(19) United States
(12) Patent Application Publication
(10) Pub. No.: US 2009/0186181 A1
(43) Pub. Date: Jul. 23, 2009

(54) Screen Protector Film with Particulate Removal Means and Method of Applying the Same

(75) Inventor: Ryoichi Mase, Tokyo (JP)

Correspondence Address: APEX JURIS, PLLC, 12733 LAKE CITY WAY NORTHEAST, SEATTLE, WA, 98125, US

(73) Assignee: Power Support Co., Ltd., Tokyo (JP)

(21) Appl. No.: 12/108,404

(22) Filed: Apr. 23, 2008

(30) Foreign Application Priority Data
Jan. 18, 2008 (JP) 2008-813

(51) Int. Cl. B32B 33/00; B32B 37/12

(52) U.S. Cl. 428/40.1; 156/60

(57) ABSTRACT

A multilayered protective film set for use with an electronic device screen having a first film layer, a second film layer, a first adhesive layer positioned between said first film layer and said second film layer, a third film layer, a second adhesive layer positioned between said second film layer and said third film layer and whereby the application method for the film set is such that dust and particulate matter is efficiently removed prior to final application of the protective film.

### FIELD OF THE INVENTION

The present invention relates to a protective film with a dust and particulate removal means designed for use with liquid crystal (LCD) screens or any other type of electronic device viewing screen.

### BACKGROUND OF THE INVENTION

For the past several years many different types of screen protectors existed in the electronics industry. Originally they were hard, thick, stiff covers that were placed over the outside of the computer screen or they were an encasement means for smaller electronic devices, such as MP3 players, electronic organizers, mobile phones or any other device that utilized an electronic viewing screen. Eventually technology advanced so that the screen protector became a thin, flexible film that is applied directly to the electronic device screen.

These previous films have several disadvantages. First, there is a problem with respect to the screen surface and the cleaning of the surface. In order to provide for good, unimpaired contact between the film and the screen surface, it is important to clean the screen surface prior to applying the screen protector film. However, no matter how careful or cautious the applier is there invariably remains dust and particulate matter that stays or returns to the device screen prior to application of the screen protector film. Any dust or particulate matter that remains causes an air bubble and thus, not a perfect seal between film and surface. If the applicant attempts to remove the particulate matter from either the film or the device surface it means removing the film from the electronic device surface and attempting to clean either the film or the electronic device surface. Once the film is applied and removed it is extremely difficult to clean the film. Also, because the film is now exposed it is susceptible to more dirt, dust and particulate matter. Further, the applier now needs to also try to re-clean the electronic device screen surface. After both the film and surface are re-cleaned, the film needs to be reapplied to the surface. As described, this removal and reapplication provides yet another opportunity for either destroying the film or for more particulate matter to come into contact with either the film or the device surface. Many times this damages the film and renders it unusable.

Next, there is the problem of accurately lining up the screen protector film with the edges of the electronic device screen. Because the screen film is cut to exacting measurements and standards there is little room for error when applying the screen film and often, if not applied properly and exactly the first time, the film must be removed from the screen surface. Again, this provides for more opportunity for the film to be damaged and for more particulate matter to come into contact with either the film or the screen surface. Also, the more times the film is applied and reapplied it can become damaged and unusable, resulting in wasted film.

In one previously commercially available protection film, the thin film is made of two film sheets. One sheet is a film with an adhesive layer. The second film is a removable film that protects the first film and the adhesive prior to application. In order to apply the film the user has to clean the electronic device screen, attempting to completely remove all dust and particulate matter, so that the film may be applied cleanly. If all particulate matter is not removed then that remaining particulate matter becomes trapped between the screen and the film, thus causing air bubbles and an imperfect adhesion between screen and film. As mentioned above, if there are air bubbles then the applier must remove the film, attempt to clean the film and the screen surface and then reapply. This is virtually impossible and often results in the destruction of the film.

Also, with this previous film type, once the protecting film is revealed the applier has one chance to exactly place the film on the electronic device screen surface. If the applier does not align the film properly then it must be removed and reapplied. Again, this generally results in destruction of the film. The present invention provides a film and method to easily and effectively remove particulate matter prior to applying the protective film and assists the applier with aligning the film prior to final application.

### SUMMARY OF THE INVENTION

The first purpose of the present invention is to provide a simple and easy method and apparatus for the removal of dust and particulate matter from an electronic device screen prior to the application of a protective film to the electronic device screen. A second purpose of the present invention is to provide for easier alignment of the finally applied protective screen film to the electronic device screen.

To solve the identified problems associated with protective films the present invention provides a protective film with multiple film layers. A first peeling film layer is designed to cover and protect a second cleaning film layer; the second cleaning film layer has a first adhesive surface and is designed to remove dust and particulate matter from the electronic device surface; the first adhesive layer is sandwiched between the first film layer and the second film layer; a second adhesive layer is adhered to a third protective film layer and is sandwiched between the second film layer and the third protective film layer and is designed to adhere to the electronic device surface; and the third protective film layer is applied to and protects an electronic device surface using the second adhesive layer.

Additionally, the second cleaning film layer can have a cut line to allow for the second cleaning film to be divided in a first section and a second section. In this way both adhesive sections can be applied to the electronic device screen and thereafter one section can be removed, taking with it dust and particulate matter. Then, one half of the third protective film can easily, accurately and finally be applied to the clean surface. Thereafter the second section can be removed, taking with it dust and particulate matter. Then, the second half of the third protective film can easily, accurately and finally be applied to the clean surface.

### BRIEF DESCRIPTION OF THE DRAWINGS

The above and other objects of the present invention will become readily apparent by reference to the following detailed description when considered in conjunction with the accompanying drawings wherein:

FIG. 1 is a sectional view of the protective film set with the first peeling film layer being larger than all other layers; the first adhesive layer and the second cleaning layer both being the same size but smaller than the first peeling film layer; the cleaning layer cut line; and the second adhesive layer and the third protective film layer both being the same size but smaller still than the cleaning layer, the second adhesive layer and the first peeling layer;

FIG. 2 is a plan view of the protective film set with the first peeling film layer, the first adhesive layer, the second cleaning layer, the cleaning layer cut line, the second adhesive layer and the third protective film layer;

FIG. 3 is a sectional view of an alternative embodiment of the protective film set similar to FIG. 1 but where all films and adhesives are the same size except for a guide portion. FIG. 3 shows the first peeling film layer, the first adhesive layer, the second cleaning layer, the cleaning layer cut line, the second adhesive layer, the third protective film layer and further shows the guide portions on either side;

FIG. 4 is a plan view of the alternative embodiment of the protective film set shown in FIG. 3 more clearly showing the guide portion;

FIG. 5 is a sectional view showing the first step of applying the second film of the protective film set to an electronic device screen surface;

FIG. 6 is a sectional view showing the second step of removing the first film section of the protective film set from the electronic device surface;

FIG. 7 is a sectional view showing the third step of applying the first half of the third protective film layer to the electronic device screen surface;

FIG. 8 is a sectional view showing the fourth step of removing the second film section of the protective film set from the electronic device surface;

FIG. 9 is a sectional view showing the electronic device screen surface with the third protective film layer finally and completely applied to the electronic device screen surface; and

FIG. 10 is an overhead plan view showing how to apply the protective film to an electronic device screen surface.

### DETAILED DESCRIPTION OF THE INVENTION

The present invention relates to a protective film set for use with an electronic device screen and a method of applying the film to the electronic device screen. Detailed descriptions of the different film configurations will be given first, followed by a detailed description of the method of applying the protective film to electronic device screens. The application methods are similar and basically apply to all different film configurations.

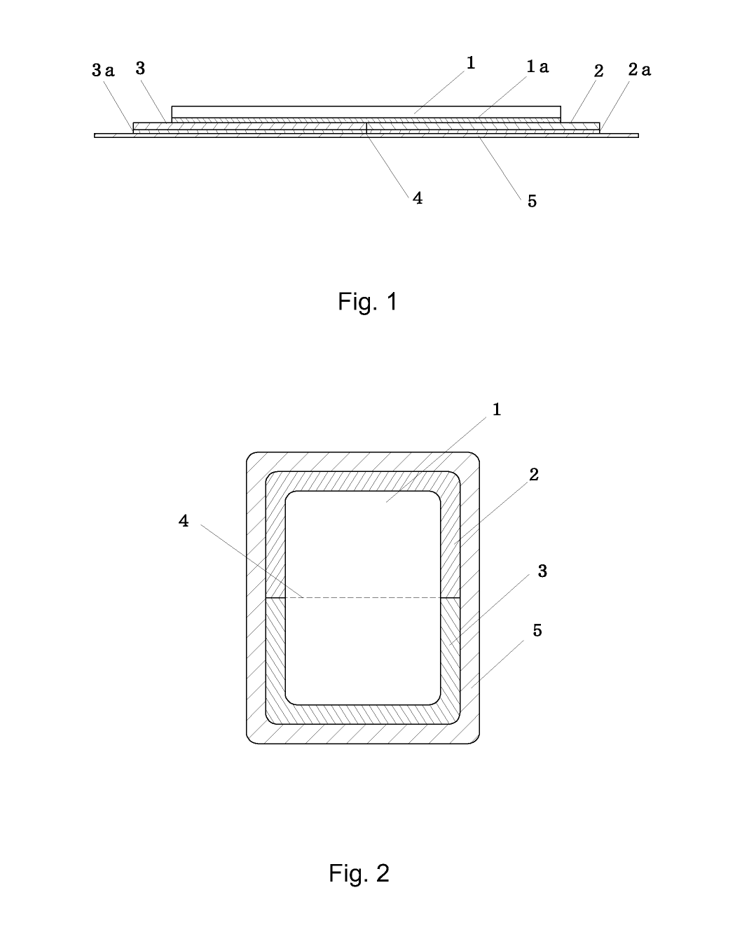

The first configuration of the film set structure will be fully explained with reference to FIGS. 1 and 2. The first film set structure is formed by utilizing different sized layers, as can be seen in FIG. 1 and FIG. 2. The different sized layers provide for easy separation one from another thus facilitating easy application of the product. As can clearly be seen in FIG. 1, there are five layers, namely, a first film peeling layer 6; a first adhesive layer 2a, 2b; a second film cleaning layer 2, 3; a second adhesive layer 1a; and a third film protective layer 1.

The first layer is a peeling film layer 6. This layer serves several purposes. First it provides protection for the additional layers prior to application, second, it is a large base for placement and layering of all additional layers and finally, because it is larger than all additional layers, it is easily removed from the additional layers, providing for easier application to the electronic device surface.

Next is a first adhesive layer that adheres to a second film cleaning layer. This adhesive layer and the cleaning layer have a cut line 4 that divides the layers into two parts; cleaning films 2 and 3 and adhesive layers 2a and 3a. The reason for this separation and division into two parts will be fully explained later with respect to the method of application. This combined first adhesive layer 2a, 3a and second film cleaning layer 2, 3 has a smaller area than the first peeling film 6 to enable the sheet to be easily removed from the first peeling film 6. The reason for the adhesive layer and the cleaning layer is to remove dust and particulate matter from the electronic device screen prior to application of a final protective film 1.

The third protective film layer 1 is designed to remain on the electronic device screen and to provide protection for the electronic device screen. It is smaller still in area than the previous two films. Again, as with the previous film, the reason for the difference in size is to allow for easy separation of the two films. This third protective film layer 1 has a second adhesive layer 1a that adheres to the third protective film layer 1 and that adhesive layer ultimately affixes the third protective film layer to the electronic device screen 9. The method of application will be more fully described later.

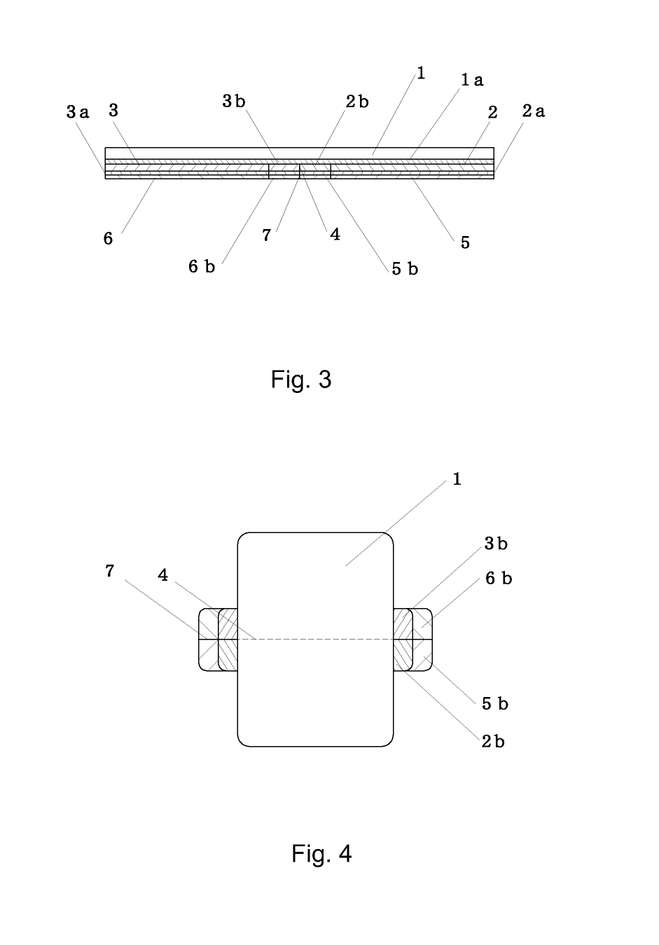

The second configuration is nearly identical to the first configuration but for the fact that instead of all the layers being different in size and area they are all the same size except for a guide section. This guide section will be fully explained with reference to FIGS. 3 and 4.

As can be seen in FIG. 4, all of the films have the identical area except for the guide sections 2b, 3b, 5b and 6b, disposed on either side of the films outer edge. As described above, the different sizes allow for easily separating the films. In this embodiment, the differing sizes are confined to smaller guides positioned on either side of the film. However, the end result is the same, that is, to provide a means to easily separate the films one from another.

The above described structure provides an easy apparatus to remove any residual dust or particulate matter from an electronic device screen and further enables easier placement of the final protective film onto the electronic device screen. The method for application will now be explained and the same method applies generally to both of the above described configurations.

When first preparing the electronic device screen surface it is recommended that the applier thoroughly clean the screen surface of dirt, smudges, dust and particulate matter. However, no matter how detailed and careful the applier may be, dust and other particulate matter typically reappear and hinder the protective screen application.

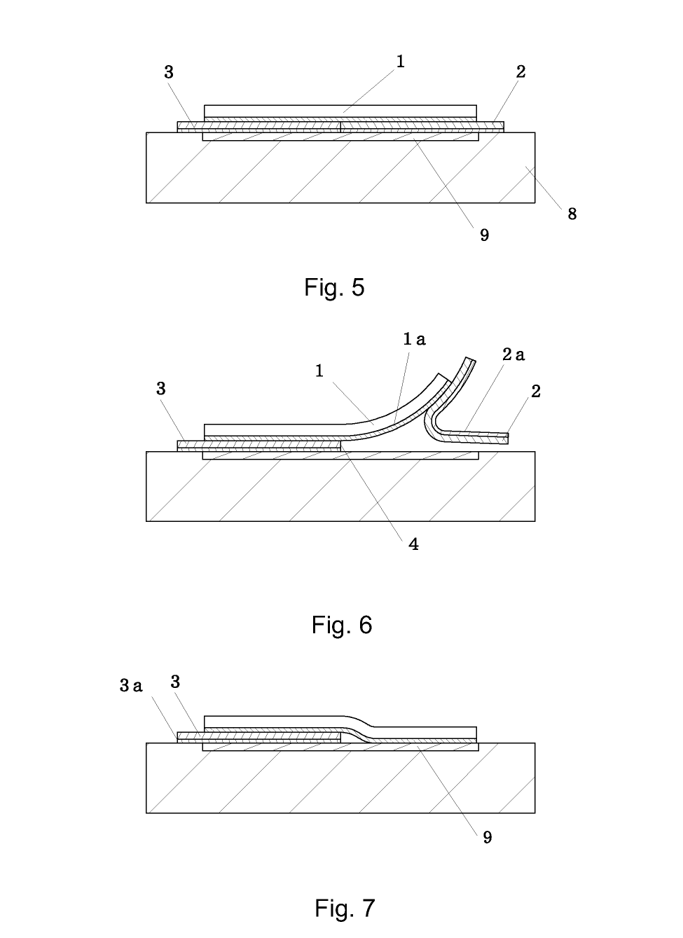

After first cleaning the device screen surface the applier takes the film screen set and pulls back half of the first peeling film layer 5 from the set. After peeling back the initial half of peeling film layer 5 the applier carefully positions the now exposed first adhesive layer 2a and the second cleaning film layer 2 on the electronic device screen surface. This film layers can be adjusted because it is not the final protective film and because the 3a, 3 half is still covered by peeling film layer 5. Once the applier correctly positions the film then applier will remove the remaining portion of peeling film layer 5. Now the adhesive layers 2a, 2b and cleaning film layers 2, 3 are in direct contact with electronic device screen as is shown in FIG. 5.

After this application step the applier will carefully remove one half of the cleaning screen, specifically sections 2a and 2, as is shown in FIG. 6. Adhesive layer 2a will attract and adhere to any dirt, dust or particulate matter remaining on the screen, so during the removal process of cleaning screen 2 any remaining dust or particulate matter will be removed from the electronic device screen.

After removal of sections 2 and 2a the second adhesive layer 1a and the third protective film layer 1 are exposed. These layers are then carefully placed on the electronic device screen surface as is shown in FIG. 7. Due to the facts that the applier only has to work with half of the film, and because half of the device screen surface is now totally free of dust and particulate matter, and because the film has already been aligned on the electronic device surface, easier application of the third protective film layer 1 is facilitated. In other words, because the dust and particulate matter has been removed there will be no air bubbles or other imperfections. Also, because the applier only has to manage one half of the film at a time the film is more easily and perfectly aligned on the electronic device surface.

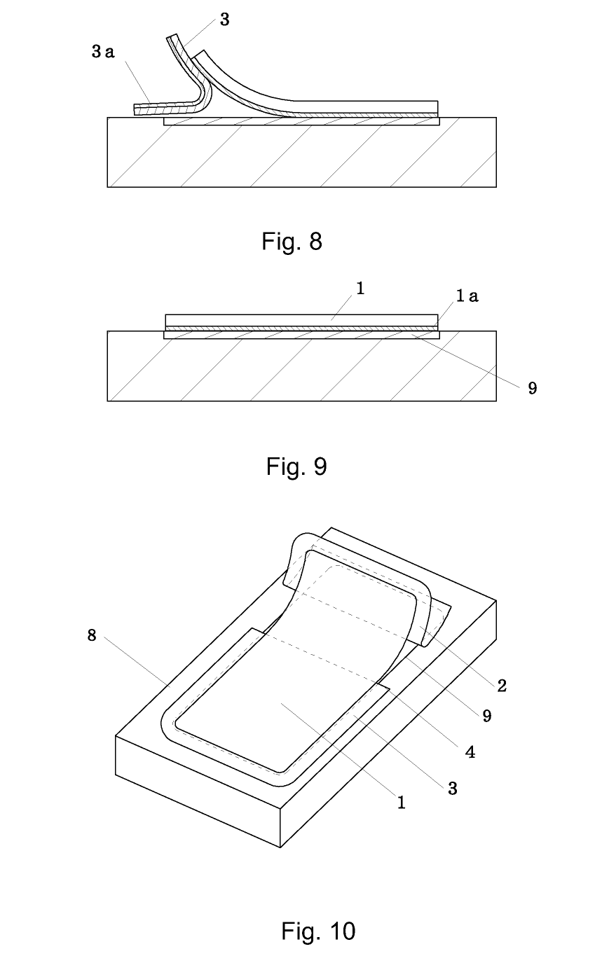

From this point, the next step is to finally apply the remaining half of the third protective film 1. Similar to the above description, the applier now removes the remaining section of the first adhesive layer 3a and second cleaning film layer 3, as is shown in FIG. 8. As with the first half, when this section is removed it takes with it any dust and particulate matter that may still remain on electronic device screen surface. After removal the applier carefully positions the second half of the second adhesive layer 1a and the second half of remaining protective film layer 1 and finally applies them to the electronic device surface. FIG. 10 shows an overhead view of the application process.

Particulate matter has all been removed by the cleaning film layer and thus, when applying the final protective film layer no bubbles or irregularities exist. Further, the film can be aligned and positioned prior to exposing the second adhesive layer 1a and because of this, placement of the final protective film layer is more precise and accurate.

It is readily apparent that the above-described configurations have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

1. A multilayered film set for use with an electronic device screen comprising:
a first film layer;
a second film layer;
a first adhesive layer positioned between said first film layer and said second film layer;
a third film layer;
a second adhesive layer positioned between said second film layer and said third film layer.

2. A film set as in claim 1 wherein said second film is divided into at least a first portion and a second portion by a cut line.

3. A film set as in claim 1 wherein said film set is flexible.

4. A film set as in claim 1 wherein said film set is translucent.

5. A film set as in claim 1 wherein said film set provides security viewing.

6. A method of applying the protective film of claim 1 to an electronic device screen, comprising the steps of:
removing said first film layer from said second film layer;
applying said second film adhesive layer side to said electronic device screen;
removing said second film and adhesive layer from said electronic device; and
applying said third film adhesive layer side to said electronic device.

7. The film according to claim 6 wherein said second film is divided into at least a first portion and a second portion by a cut line.

8. The film according to claim 7, further comprising the steps of:
removing said the first portion of said second film adhesive layer from said electronic device;
applying the first portion of said third film adhesive layer side to said electronic device;
removing the second portion of said second film adhesive layer from said electronic device;
applying a second portion of said third film adhesive layer side to said electronic device.

9. The method according to claim 6 wherein said film set is flexible.

10. The method according to claim 6 wherein said film set is translucent.

11. The method according to claim 6 wherein said film set provides for security viewing.
